(19) United States
(12) Patent Application Publication
(10) Pub. No.: US 2007/0177498 A1
(43) Pub. Date: Aug. 2, 2007

(54) Method and apparatus for implementing speculative credit flow control

(75) Inventors: Scott Douglas Clark, Rochester, MN (US); Jeffrey Joseph Ruedinger, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/344,904

(22) Filed: Feb. 1, 2006

(51) Int. Cl. H04L 12/26

(52) U.S. Cl. 370/229

(57) ABSTRACT

A method and apparatus are provided for implementing speculative credit flow control in a data communications link. A receiving node selects and sends a number of speculative credits as part of a total number of credits sent to a transmitting node. The receiving node receives and processes communications from the transmitting node. The receiving node dynamically determines when a change is needed for the number of speculative credits and updates the number of speculative credits. The number of speculative credits is selected for optimizing performance on the communications link.

### FIELD OF THE INVENTION

The present invention relates generally to the data processing field, and more particularly, relates to a method and apparatus for implementing speculative credit flow control in a data communications link.

### DESCRIPTION OF THE RELATED ART

In a data communications link, one common method of flow control is to use a credit based mechanism whereby a receiving node will send a set of credits to a transmitting node that is equal to the amount of buffer space available in the receiving node.

The unit of measure for the credit corresponds to a packet, command, data transfer, or other predefined logical unit of information transfer. The transmitting node is then allowed to send the corresponding type of transfer up to the amount of credits received from the receiving node, thereby preventing overflowing the receiving buffer space.

When the receiving node is able to process the information received in the input buffer space equal to or typically faster than the transmitting node is able to send, then this credit based mechanism is inefficient in that the receiving buffer space will not or will typically not be fully utilized, thus wasting area on the receiving chip's die resulting in more cost and power for that chip.

For example, referring to FIG. 1, in a typical credit flow control mechanism between a transmitting node and a receiving node along path X, if the Receive buffer had m storage locations for information from the transmitting node, the receiving node would send m credits to the transmitting node initially. As long as the transmitting node has a positive value of credits, the transmitting node can send a packet of information and then decrement its credit accumulation.

Buffer space in the receiver is often needed to keep the flow of data from transmitter to receiver continuous and as fast as possible over path X. However, if path Y can unload faster than data can arrive, buffer space in the receiver may never be used. If the receive buffer is always able to empty equal to faster than the sender can fill it, then any excess receiver buffer space can be removed. However if path Y sometimes is not able to empty fast enough, for example, due to infrequent bottlenecks, then the receiver must implement buffer space for each credit issued to avoid losing data. Given that a retry or other mechanism to prevent data loss exists to resend data from sender to receiver, for example, in case of a transmission error, a more efficient method of implementing buffer space in the receiver is possible.

A need exists for an effective and efficient mechanism that more fully utilizes receiving buffer space, and avoids wasting area on the receiving chip's die, minimizing cost and power for the chip.

As used in the following description and claims, the term “speculative credits” refers to credits issued by a receiving node that are over and above those credits corresponding to an actual buffer space implemented by the receiving node.

### SUMMARY OF THE INVENTION

A principal aspect of the present invention is to provide a method and apparatus for implementing speculative credit flow control in a data communications link. Other important aspects of the present invention are to provide such method and apparatus for implementing speculative credit flow control in a data communications link substantially without negative effect and that overcome many of the disadvantages of prior art arrangements.

In brief, a method and apparatus are provided for implementing speculative credit flow control in a data communications link. A receiving node selects and sends a number of speculative credits as part of a total number of credits sent to a transmitting node. The receiving node receives and processes communications from the transmitting node. The receiving node dynamically determines when a change is needed for the number of speculative credits and updates the number of speculative credits.

In accordance with features of the invention, the number of speculative credits is selected for optimizing performance on the communications link. For example, a selected number of speculative credits is decreased to prevent excessive retrying on the communications link, and a selected number of speculative credits is increased to increase transmissions on the communications link. The number of speculative credits is selected so that resulting additional packets in flight is not larger than the round trip credit and packet transmission path between the transmitting and receiving nodes.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram illustrating prior art credit flow control in a data communications link; and

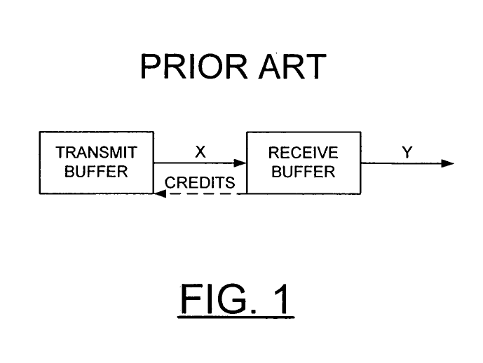

FIG. 2 is a block diagram illustrating apparatus for implementing speculative credit flow control in a data communications link in accordance with the preferred embodiment;

FIG. 3 is a logic flow chart illustrating exemplary steps for implementing speculative credit flow control in a data communications link in accordance with the preferred embodiment; and

FIG. 4 is a block diagram illustrating a computer program product in accordance with the preferred embodiment.

### DETAILED DESCRIPTION OF THE PREFERRED EMBODIMENTS

In accordance with features of the invention, an improved method is provided for allocating credits for flow control in a data communications link. A concept of “speculative credits” is provided that is used to allocate more credits than buffer space is available in order to prevent unnecessary backpressure to the transmitting node while reducing the buffer space required in the receiving node in order to maximize bandwidth on the communications link.

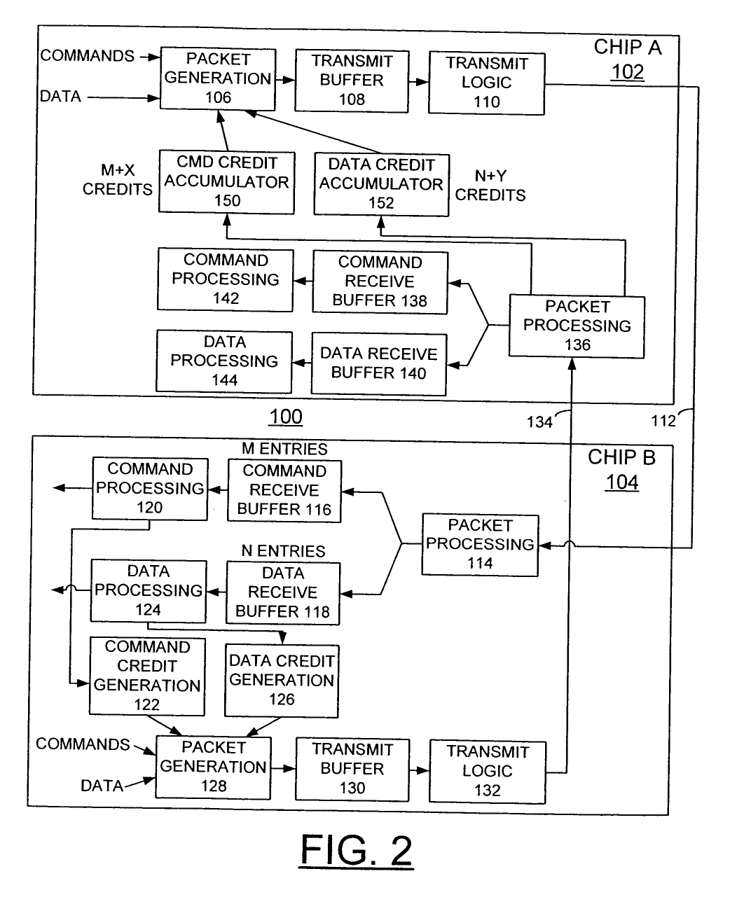

Having reference now to the drawings, in FIG. 2, there is shown apparatus for implementing speculative credit flow control in a data communications link generally designated by the reference character 100 in accordance with the preferred embodiment. Data communications link apparatus 100 includes a first chip A, 102 and a second chip B, 104

First chip A, 102 includes packet generation logic 106 receiving commands and data and applying packets to a transmit buffer 108. Packets are coupled by transmit logic 110 to second chip B, 104 via a communications link 112.

Second chip B, 104 includes packet processing logic 114 receiving commands and data packets and applying command packets to a command receive buffer 116 and a data receive buffer 118.

It should be understood that the present invention is not limited to use for flow control for command and data, the present invention is applicable to other types of traffic and can include additional subclasses of communications.

Command packets are processed by command processing logic 120 and applied to a command credit generation function 122 of the preferred embodiment. Data packets are processed by data processing logic 124 and applied to a data credit generation function 126 of the preferred embodiment.

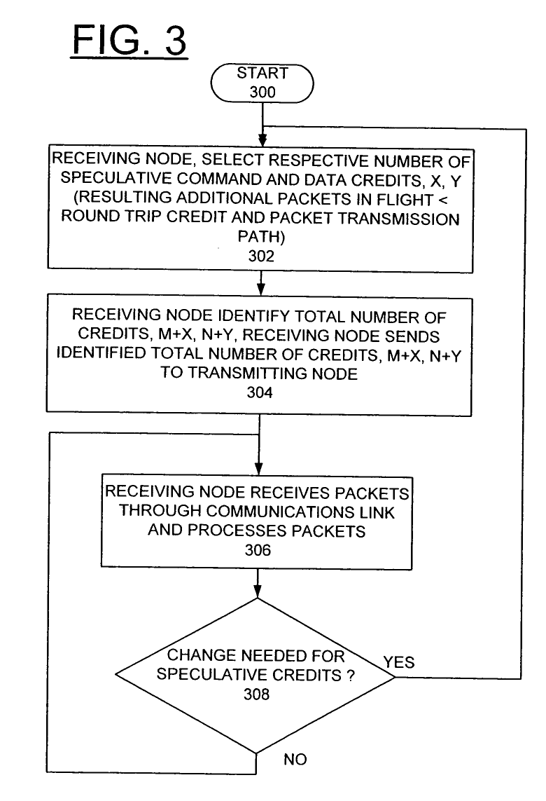

FIG. 3 provides a logic flow chart illustrating exemplary steps for implementing speculative credit flow control in a data communications link 112 in accordance with the preferred embodiment. Speculative credit flow control advantageously is dynamically configured by software or hardware of the command credit generation function 122 of the preferred embodiment and the data credit generation function 126 of the preferred embodiment.

A packet generation logic 128 receives command credit and data credit information from the command credit generation function 122 and the data credit generation function 126. The packet generation logic 128 also receives commands and data. The packet generation logic 128 applies packets including data and command speculative credit information to a transmit buffer 130. The packets including data and command speculative credit information from transmit buffer 130 are coupled by transmit logic 132 to first chip A, 102 via a communications link 134.

First chip A, 102 includes packet processing logic 136 receiving commands and data packets and applying command packets to a command receive buffers 138 and a data receive buffer 140. Command packets are processed by command processing logic 142 and data packets are processed by data processing logic 144.

First chip A, 102 includes a command credit accumulator 150 of the preferred embodiment and a data credit accumulator 152 of the preferred embodiment coupled to the packet processing logic 136. Command credit accumulator 150 and data credit accumulator 152 apply credit information to the packet generation logic 106.

In accordance with features of the invention, command credit accumulator 150 of the preferred embodiment receives M+X credits, where the command received buffer 116 of second chip B, 104 includes M entries. Data credit accumulator 152 of the preferred embodiment receives N+Y credits, where the data received buffer 118 of second chip B, 104 includes N entries.

Referring now to FIG. 3, there are shown exemplary steps for implementing speculative credit flow control in a data communications link in accordance with the preferred embodiment starting at a block 300. As indicated in a block 302, a respective number of speculative credits X, Y is selected for command and data, for example, by the command credit generation function 122 and data credit generation function 124. The respective number of speculative credits X, Y is selected, for example, so that resulting additional packets in flight is not larger than the round trip credit and packet transmission path between the transmitting and receiving nodes.

As indicated in a block 304, a total number of credits M+X, N+Y, are identified including the respective number of speculative credits X, Y for command and data packets, for example, by the command credit generation function 122 and data credit generation function 124, and the receiving node chip B, 104 sends the identified total number of credits M+X, N+Y, for example, by transmit logic 132 over communications link 134 to the transmitting node chip A, 102. The receiving node receives and processes packets as indicated in a block 306.

In accordance with features of the invention, by allowing the receiving node to send a respective number of speculative credits X, Y for commands and data, such that the respective total number of credits sent to the transmitting node is M+X, N+Y, where the Command Receive Buffer 116 includes M entries, and Data Receive Buffer 118 includes N entries. The respective number of speculative credits X, Y for commands and data is selected such that the resulting additional packets in flight is not larger than the round trip credit and packet transmission path, the receiving node buffers, such as the Command Receive Buffer 116, and Data Receive Buffer 118 can be fully utilized, and the bandwidth on communications path can be fully realized. This technique advantageously is used to either reduce the buffering required for buffers 116, 118 on the receiving node second chip B, 104 to achieve a particular bandwidth on communications link 112, or to achieve a higher bandwidth on communications link 112 with a given amount of buffering of buffers 116, 118 on the receiving node second chip B, 104.

In accordance with features of the invention, the rate at which path out empties the Receive Buffers 116, 118 can be variable such that at times it may be slower than the communications link rate filling the buffers 116, 118, and typically these times are exception cases and not the normal flow of operations, as long as a mechanism for retrying the communication link exists in the cases where one of the Receive Buffers 116, 118 is full when a new packet of information is received, then the techniques advantageously are still applied to achieve a higher bandwidth with a smaller receive buffer size than with conventional credit flow control.

As indicated in a decision block 308, dynamic checking is performed to determine when the number of speculative credits X, Y issued to the transmitting node, such chip A, 102, needs to be changed for optimizing performance on the communications link, for example, to prevent excessive retrying on the communications link, or to increase transmissions on the communications link. For example, the number of speculative credits X, Y issued to the transmitting node needs to be changed when a receiver buffer empty rate is less than a receiver buffer fill rate for a predefined time period.

In accordance with features of the invention, the number of speculative credits X, Y issued to the transmitting node chip A, 102 advantageously is dynamically configurable through software or hardware for optimizing performance on the communications link. Also, for extreme cases when emptying rate E may be slower than fill rate F for long lengths of time, software or hardware advantageously can reduce the number of speculative credits X, Y to zero to prevent excessive unnecessary retrying on the communications link, such as communications link 112. When normal operation resumes, software or hardware advantageously can reconfigure speculative credits to achieve better link utilization.

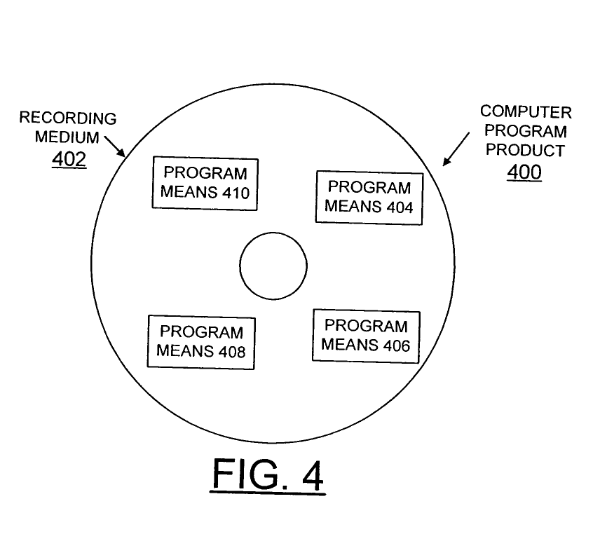

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing speculative credit flow control of the preferred embodiment in the data communications link 100 of FIG. 2.

A sequence of program instructions or a logical assembly of one or more interrelated modules defined by the recorded program means 404, 406, 408, 410, direct the data communications link 100 for implementing speculative credit flow control of the preferred embodiment.

While the present invention has been described with reference to the details of the embodiments of the invention shown in the drawing, these details are not intended to limit the scope of the invention as claimed in the appended claims.

What is claimed is:

1. A method for implementing speculative credit flow control in a data communications link including a transmitting node and a receiving node, said method performed by the receiving node comprising the steps of:
selecting a number of speculative credits and sending a total number of credits to the transmitting node; said total number of credits including said selected number of speculative credits;
receiving and processing communications from the transmitting node;
dynamically determining when a change of the number of speculative credits is needed; and
updating said selected number of speculative credits and sending said total number of credits to the transmitting node including an updated selected number of speculative credits.

2. A method for implementing speculative credit flow control as recited in claim 1 wherein selecting said number of speculative credits includes selecting said number of speculative credits for optimizing performance on the communications link.

3. A method for implementing speculative credit flow control as recited in claim 1 wherein updating said selected number of speculative credits includes decreasing said selected number of speculative credits to prevent excessive retrying on the communications link.

4. A method for implementing speculative credit flow control as recited in claim 1 wherein updating said selected number of speculative credits includes increasing said selected number of speculative credits to increase transmissions on the communications link.

5. A method for implementing speculative credit flow control as recited in claim 1 wherein selecting said number of speculative credits includes selecting said number of speculative credits to provide resulting additional packets in flight being less than a round trip credit and packet transmission path between the transmitting and receiving nodes.

6. A method for implementing speculative credit flow control as recited in claim 1 wherein updating said selected number of speculative credits includes decreasing said selected number of speculative credits to zero responsive to a receiver buffer empty rate being less than a receiver buffer fill rate for a predefined time period.

7. A computer program product for implementing speculative credit flow control in a data communications link including a transmitting node and a receiving node; said computer program product including instructions executed by the receiving node to cause the receiving node to perform the steps comprising:
selecting a number of speculative credits and sending a total number of credits to the transmitting node; said total number of credits including said selected number of speculative credits;
receiving and processing communications from the transmitting node;
dynamically determining when a change of the number of speculative credits is needed; and
updating said selected number of speculative credits and sending said total number of credits to the transmitting node including an updated selected number of speculative credits.

8. A computer program product for implementing speculative credit flow control as recited in claim 7 wherein selecting said number of speculative credits includes selecting said number of speculative credits for optimizing performance on the communications link.

9. A computer program product for implementing speculative credit flow control as recited in claim 7 wherein updating said selected number of speculative credits includes decreasing said selected number of speculative credits to prevent excessive retrying on the communications link.

10. A computer program product for implementing speculative credit flow control as recited in claim 7 wherein updating said selected number of speculative credits includes increasing said selected number of speculative credits to increase transmissions on the communications link.

11. A computer program product for implementing speculative credit flow control as recited in claim 7 wherein selecting said number of speculative credits includes selecting said number of speculative credits to provide resulting additional packets in flight being less than a round trip credit and packet transmission path between the transmitting and receiving nodes.

12. A computer program product for implementing speculative credit flow control as recited in claim 7 wherein updating said selected number of speculative credits includes decreasing said selected number of speculative credits to zero responsive to a receiver buffer empty rate being less than a receiver buffer fill rate for a predefined time period.

13. Apparatus for implementing speculative credit flow control in a data communications link a transmitting node and a receiving node, comprising:
packet processing logic for receiving and processing communications from the transmitting node;
a credit generation function coupled to said packet processing logic for selecting a number of speculative credits;
transmit logic coupled to said credit generation function for sending a total number of credits to the transmitting node; said total number of credits including said selected number of speculative credits;
said credit generation function for dynamically determining when a change of the number of speculative credits is needed; and
said credit generation function for updating said selected number of speculative credits and sending said total number of credits to the transmitting node including an updated selected number of speculative credits.

14. Apparatus for implementing speculative credit flow control as recited in claim 13 wherein said communications from the transmitting node include commands and data packets, and further includes a command receive buffer coupled to said packet processing logic and a data receive buffer coupled to said packet processing logic.

15. Apparatus for implementing speculative credit flow control as recited in claim 13 wherein said command receive buffer include M entries, and said data receive buffer includes N entries.

16. Apparatus for implementing speculative credit flow control as recited in claim 13 wherein said selected number of speculative credits include a respective number of speculative credits X, Y for commands and data and said total number of credits sent to the transmitting node includes a respective total number of credits M+X, N+Y.

17. Apparatus for implementing speculative credit flow control as recited in claim 13 wherein said credit generation function updates said selected number of speculative credits for optimizing performance on the communications link.

18. Apparatus for implementing speculative credit flow control as recited in claim 13 wherein said credit generation function increases said selected number of speculative credits to increase transmissions on the communications link.

19. Apparatus for implementing speculative credit flow control as recited in claim 13 wherein said credit generation function decreases said selected number of speculative credits to prevent excessive retrying on the communications link.
